(19) United States
(12) Patent Application Publication
(10) Pub. No.: US 2026/0111606 A1
(43) Pub. Date: Apr. 23, 2026

(54) System

(71) Applicant: Softbank Group Corp., Tokyo (JP)

(72) Inventor: Shuhei Takahara, Tokyo (JP)

(21) Appl. No.: 19/360,406

(22) Filed: Oct. 16, 2025

(30) Foreign Application Priority Data
Oct. 18, 2024 (JP) 2024-183856

(51) Int. Cl. G06F 21/62

(52) U.S. Cl. CPC G06F 21/6254

(57) ABSTRACT

A system includes a processor that receives information, analyzes the received information to detect confidential information and personal information, automatically replaces or deletes detected confidential information and personal information, transmits the processed information to an external service, and records the processing steps.

### CROSS-REFERENCE TO RELATED APPLICATION

This application is based on and claims priority under 35 USC 119 from Japanese Patent Application No. 2024-183856 filed on Oct. 18, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, the use of external artificial intelligence (AI) services for processing various kinds of information has rapidly increased in enterprises. However, when confidential information or personal information is inadvertently included in data sent to such services, there is a significant risk of information leakage, which can result in legal, social, and business problems. Conventional systems do not provide sufficient mechanisms to automatically detect and protect such sensitive information before transmission to external services, increasing the risk of data breaches.

### SUMMARY

The present invention provides an information processing system including a processor configured to receive information, analyze the received information to detect confidential and personal information, automatically replace or delete the detected information, transmit the processed information to an external service, and record the processing steps. By using natural language processing techniques for detection and pre-defined placeholders for replacement, the system effectively prevents the leakage of sensitive information when utilizing external AI services.

“Processor” means a device or a set of devices configured to execute instructions and perform data processing tasks within the information processing system.

“Information” means any data, including text, files, or documents, which may contain confidential information or personal information to be processed by the system.

“Confidential information” means information which is sensitive to an organization or individual, and whose unauthorized disclosure may cause harm or undesired consequences.

“Personal information” means information which relates to an identified or identifiable individual, such as names, addresses, or contact details.

“Replace” means to substitute detected confidential information or personal information in the data with pre-defined placeholders.

“Delete” means to remove detected confidential information or personal information from the data, so that it is no longer present in the processed information.

“External service” means a remote system, platform, or application, such as a generative AI service, which processes information received from the information processing system.

“Processing steps” means the sequence of actions undertaken by the system to analyze, replace or delete sensitive information, transmit data, and perform other related tasks.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

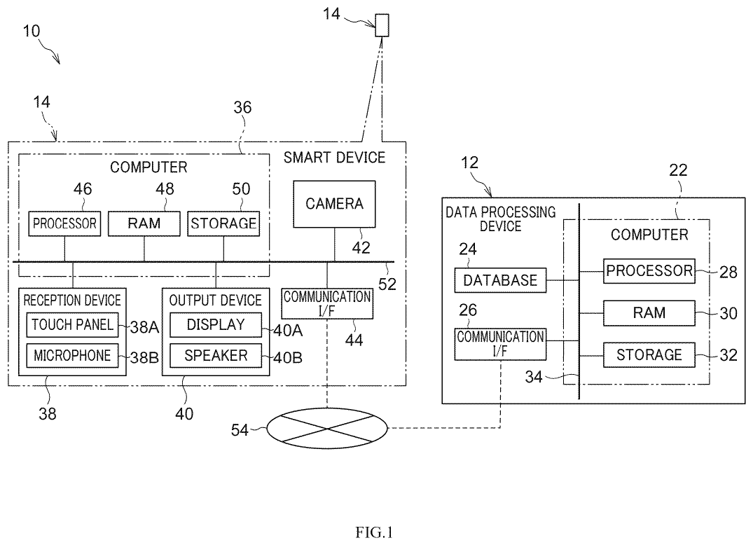

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

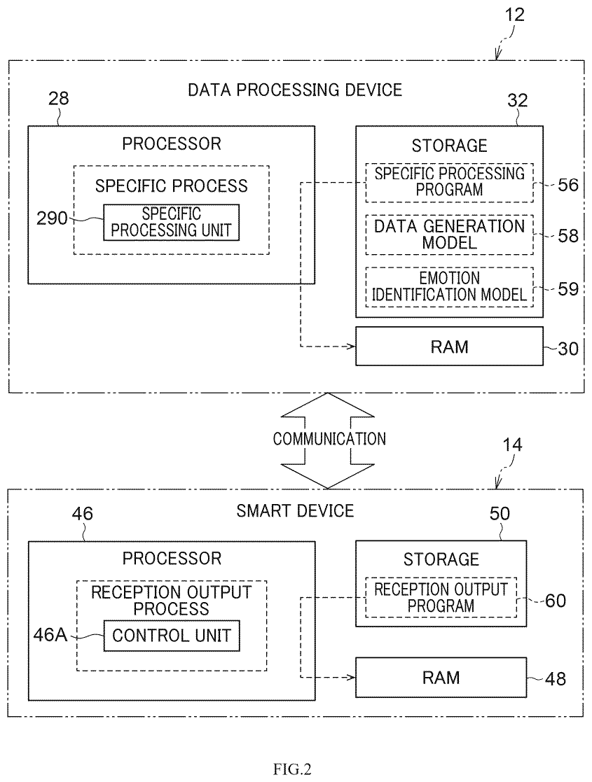

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the current technological environment, there is a growing demand to utilize external generative information processing apparatuses, such as generative AI models, while maintaining the confidentiality and security of sensitive and personally identifiable information contained in data to be transmitted. Conventional systems often lack effective mechanisms for automatically anonymizing or masking such information before data is transmitted outside a secure network, resulting in an increased risk of data leakage and non-compliance with information security regulations. Furthermore, there is a need to provide reliable audit trails of the entire data handling and anonymization process to meet organizational policies and legal requirements.

The specific processing by the specific processing unit 290 of the data processing device 12 in Example 1 is realized by the following means.

The present invention provides a server comprising a processor configured to receive input data, verify the integrity of the data, perform natural language analysis to extract and identify highly-confidential or personally identifiable attributes, automatically replace or remove such attributes with higher-level concept identifiers, transmit the anonymized data to an external generative information processing apparatus with an accompanying prompt sentence, and record time-stamped logs of these processing steps. This enables organizations to safely utilize external generative information processing services without exposing confidential or sensitive information, while also maintaining comprehensive processing records for accountability and compliance.

The term “input data” refers to information or content provided for processing, which may contain sensitive or personally identifiable information requiring analysis and anonymization.

The term “processor” refers to a computing unit that executes instructions for data handling, analysis, anonymization, communication, and recording operations as described in the present invention.

The term “integrity” refers to the state in which the received input data is accurate, unaltered, and verified to be complete and trustworthy.

The term “electronic device suitable for natural language analysis processing” refers to a hardware or software system capable of processing language data and performing tasks such as parsing, tokenizing, or named entity recognition.

The term “natural language processing technology” refers to computational methods and algorithms that analyze, interpret, and manipulate human language in a machine-readable manner.

The term “attribute information” refers to data elements within the input data that represent confidential, sensitive, or personally identifiable details such as names, addresses, or unique identifiers.

The term “high-confidentiality attribute information” refers to data elements in the input data that carry a significant privacy or secrecy risk if exposed, such as passwords, financial data, or classified company information.

The term “highly-identifiable attribute information” refers to data elements that can readily be linked to a specific individual, such as full names, telephone numbers, or identification numbers.

The term “higher-level concept identifier” refers to a generalized or abstract label or symbol used to replace specific confidential or identifiable attribute information during anonymization, such as replacing “John Smith”with “Name”.

The term “external generative information processing apparatus” refers to a system, platform, or service outside the secured domain, capable of generating data, responses, or content upon receiving an input, such as a generative AI model.

The term “prompt sentence” refers to an instruction or descriptive text sent together with anonymized input data, intended to guide the external generative information processing apparatus in performing its data generation task.

The term “processing details” refers to information that describes each stage of data handling, including modifications, transmissions, and log entries.

The term “time information” refers to data indicating when each step of the data processing, anonymization, and transmission occurred, enabling precise auditing and tracking.

One embodiment for implementing the invention is as follows.

The server comprises a processor and is connected to at least one terminal and to an external generative information processing apparatus via a network. The server may be implemented as a general-purpose computing device, such as a workstation or virtualized computing environment running under a common operating system (for example, a Linux-based server environment). The terminal may be implemented as a personal computer, tablet, or other smart device on which natural language processing software can be executed.

The server is configured to receive input data, which may include text documents or other files provided by the user via the terminal. The server verifies the integrity of the received input data, for instance, by checking hash values or digital signatures, and determines whether it is safe and complete for further processing. After verification is completed, the server transfers the input data to a terminal for natural language analysis.

The terminal is equipped with natural language processing software, such as a Python-based language processing library (for example, spaCy or NLTK), capable of tokenizing, parsing, and performing named entity recognition on the received input data. The terminal analyzes the input data to extract high-confidentiality attribute information and highly-identifiable attribute information, including, by way of example, names, phone numbers, addresses, and other information that could pose a privacy concern if leaked.

Upon detecting such attribute information, the terminal replaces each attribute with a higher-level concept identifier or a generic symbol, according to predefined mapping rules or dictionaries stored within the terminal. For example, a detected personal name in the text may be replaced by the identifier “Name,” while a detected phone number may be replaced by “Phone Number.” In some cases, the attribute information may be removed if replacement is not suitable.

Once the anonymization process is complete, the terminal transmits the anonymized input data back to the server. The server generates a prompt sentence, which is included with the anonymized input data when sending it to the external generative AI model or other generative information processing apparatus. For example, the prompt sentence may be: “Please proofread the following document. Names and phone numbers in the text have already been anonymized.”

The server then sends the combined anonymized input data and prompt sentence to the external generative AI model via a secure communication protocol such as HTTPS. The server also records and maintains processing details, including input data modification steps, replacement mappings, timestamps for each processing stage, and evidence of secure transmission. These logs may be stored in a database or as secure server log files, ensuring comprehensive accountability and auditability.

This embodiment allows organizations to safely utilize the capabilities of external generative information processing apparatuses while preventing the transmission of confidential or highly-identifiable information and ensuring robust traceability of all actions performed on the data.

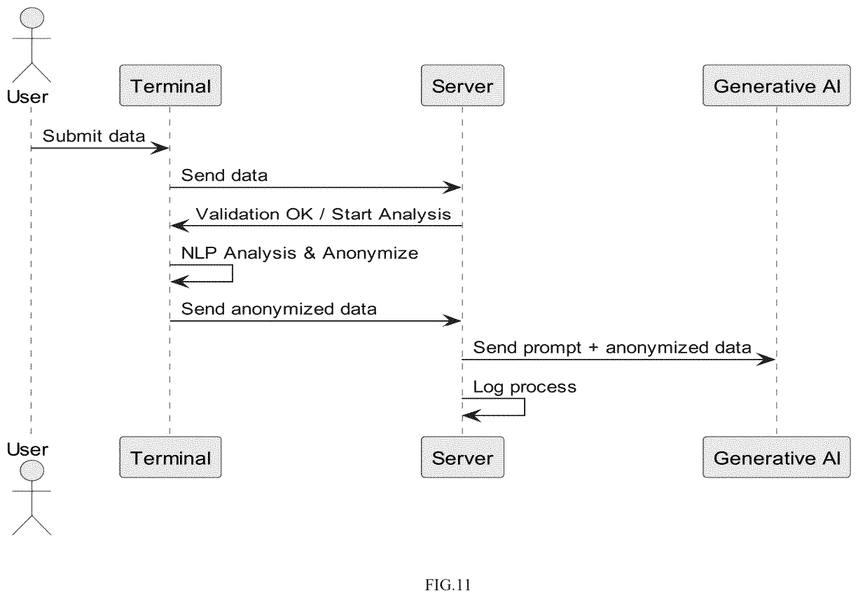

The following describes the processing flow using FIG. 11.

### Step 1:

The user prepares and submits an input data file, such as a document containing confidential or personal information, to the terminal. The input is typically provided through a user interface or upload function on the terminal. The terminal receives the file as input, temporarily saves it to local storage, and records the file metadata. The output of this action is the raw input data file available in the terminal's local system.

### Step 2:

The terminal transmits the received input data to the server over a secure network protocol, such as HTTPS. The input for this step is the raw input data file from local storage. The terminal may also calculate a checksum value and send it together with the data for later integrity validation. The output is the delivery of the data file and its associated checksum to the server.

### Step 3:

The server receives the input data file and its checksum from the terminal. The server processes the input by verifying file integrity, using the checksum or alternative validation methods, to ensure the data was not altered during transmission. The input data is the raw file and checksum; the output is either a confirmation of integrity and a signal to proceed or a rejection if errors are detected.

### Step 4:

The server transfers the validated input data to the terminal for natural language analysis processing. The input to this step is the confirmed, unaltered input data file. The server sends an instruction to the terminal to begin analysis. The output is the instruction and the input data file ready for language analysis on the terminal.

### Step 5:

The terminal executes natural language analysis using a language processing library, such as spaCy or NLTK. As input, the terminal uses the received data file and pre-configured pattern lists or dictionaries for detecting attribute information. The terminal processes the data by tokenizing, parsing, and running named entity recognition or pattern-based extraction to find high-confidentiality and highly-identifiable attribute information. The output is a list of detected attribute information and their respective positions in the data.

### Step 6:

The terminal generates an anonymized version of the input data by replacing or removing detected attribute information with higher-level concept identifiers, such as replacing names with “Name” or phone numbers with “Phone Number.” The input for this step is the original data file and the list of detected attributes. The terminal processes the text using string replacement or regular expressions, referencing mappings from a predefined dictionary. The output is an anonymized data file and a mapping log that records the replacements.

### Step 7:

The terminal transmits the anonymized data file and mapping log back to the server. The input is the anonymized file produced in the previous step. The server receives and stores the anonymized data for further processing. The output is the successful reception of anonymized data by the server.

### Step 8:

The server generates a prompt sentence, such as “Please proofread the following document. Names and phone numbers in the text have already been anonymized.” The input to this step is the anonymized data file. The server prepares a combined package of the prompt sentence and the anonymized data for transmission. The output is the ready-to-send message including the prompt and the anonymized content.

### Step 9:

The server sends the prompt sentence along with the anonymized data to an external generative AI model using a secure interface, such as an API call over HTTPS. The input is the package created in the previous step. This action outputs a request to the external generative AI model.

### Step 10:

The server records processing details in a log system, including the mapping log, steps performed, timestamps, and evidence of data integrity at each stage. The input is all the process data generated through the previous steps. The output is a persistent, time-stamped log entry available for audit and compliance purposes.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In modern information communication environments, there is a significant risk of confidential data and personal data leakage during the exchange of messages or documents, especially when utilizing external information processing services such as generative AI models. Conventional solutions are often inadequate to ensure both high security of sensitive information and efficient interaction with external services. Furthermore, inappropriate responses that do not consider the user's emotional state can diminish user satisfaction and trust. There is, therefore, a demand for a system that can safely process and relay information, prevent leakage of confidential and personal data, and provide user-friendly responses tailored to users' emotional conditions.

The specific processing by the specific processing unit 290 of the data processing device 12 in Application Example 1 is realized by the following means.

The present invention provides a server comprising a processor configured to receive information, analyze the information to detect confidential and personal data using natural language processing techniques, automatically replace or delete such detected data using predefined encoded elements, generate an input instruction sentence to be attached to the transmitted information, transmit the processed information to an external information processing service, analyze response data received from the external service to re-detect and replace or remove confidential and personal data, analyze user emotion, and adjust the content or manner of output information according to the user's emotional state, while recording the processing history. This enables secure and efficient information sharing with external services by reducing the risk of information leakage and improving user experience through emotion-adaptive output.

The term “processor” refers to a hardware device or a combination of hardware and software configured to perform information processing tasks, execute instructions, and control data flow within the system.

The term “confidential data” refers to information that is designated or determined to require protection from unauthorized disclosure, including but not limited to business secrets, sensitive organizational data, or any information whose leakage could cause harm or loss.

The term “personal data” refers to information that relates to an identified or identifiable individual, including but not limited to names, addresses, telephone numbers, email addresses, identification numbers, and any other data that can be used to identify a specific person.

The term “external information processing service” refers to a system or service accessible through electronic communication means, such as a network, that receives, analyzes, or processes information input from external entities, and includes but is not limited to generative AI models and cloud-based computing services.

The term “natural language processing techniques” refers to computer algorithms and procedures for analyzing, understanding, or generating human language, including tokenization, named entity recognition, sentiment analysis, and other linguistic processing methods.

The term “predefined encoded elements” refers to placeholders or symbolic representations, specified in advance, that are used to substitute for confidential data or personal data within information so as to prevent the disclosure of actual sensitive or personal details.

The term “input instruction sentence” refers to a prompt sentence or textual command generated to direct an external information processing service on how to analyze, process, or generate information based on the transmitted data.

The term “response data” refers to information or output received from an external information processing service as a result of transmitting processed or anonymized input data. The term “emotion analysis” refers to the process of analyzing textual or contextual information to detect, estimate, or classify the emotional state or sentiment expressed by a user.

The term “processing history” refers to a chronological record of operations, data transformations, and decision points executed within the system, including details of data receipt, analysis, anonymization, transmission, and response handling.

The term “content or manner of output information” refers to the substance and/or the expressive style or tone of the information presented to a user or external party as determined by system analysis and processing outcomes.

### Embodiment for Implementing the Invention

The present invention may be implemented as an information processing system comprising a server, a terminal device, and external information processing services such as generative AI models.

The server includes a processor, which may be realized by a general-purpose computing device such as a computer server or a cloud-based computing resource. The terminal device may be any data input device, for example, a smartphone, tablet, or wearable computing device such as smart glasses, which is equipped with a CPU, memory, and communication interfaces.

The user operates the terminal to input textual or spoken information, such as a message, inquiry, or document. The terminal is equipped with software modules for data acquisition (including speech-to-text conversion where needed), natural language processing (NLP), and sentiment or emotion analysis. For NLP, the terminal may use software libraries such as spaCy or NLTK, and for emotion analysis, it may use machine learning models provided via open-source frameworks like Huggingface Transformers.

Upon acquiring the user input, the terminal analyzes the data to detect any confidential data or personal data by applying natural language processing techniques such as tokenization, named entity recognition (NER), and pattern matching. Entities such as names, account identifiers, telephone numbers, addresses, and similar are detected as confidential or personal data.

After detection, the terminal automatically replaces or deletes the detected data using predefined encoded elements, such as “[NAME]”, “[PHONE_NUMBER]”, or “[USER_ID]”, according to the type of data. The anonymized message is then prepared to be transmitted safely.

Additionally, the terminal analyzes the input to estimate the user's emotional state, for example, “neutral,” “anger,” or “joy. ” The detected emotion is attached as metadata to the processed information.

The terminal transmits the anonymized information and associated emotion data to the server using a secure protocol such as HTTPS. The server receives the data and generates a prompt sentence for the external generative AI model, which may be deployed on an external computing infrastructure accessed via API. The server can use REST API protocols or similar to send the data to the AI model, such as those provided by general-purpose AI service providers.

The server also records the entire process, including receipt of data, anonymization actions, prompt generation, emotion analysis results, and responses, in a log database such as PostgreSQL for future auditing and compliance.

Upon receiving the response data from the generative AI model, the server performs another check to ensure that no confidential or personal data is contained in the response. If any sensitive data is found, the server replaces or removes it as necessary. The server then evaluates the user's emotional context to adjust the tone or manner of the output before delivering the final response back to the terminal.

The terminal displays the anonymized and context-appropriate response to the user. Throughout the process, comprehensive logs of all actions and data transformations are maintained for traceability and risk management.

Specific hardware that may be used includes smartphones, tablets, or wearable devices (for example, devices manufactured by generic device providers); cloud-based general-purpose computers for the server; and standard networking equipment for secure communications.

### Practical Example

Assume a user inputs the following message on a smartphone:

“Please summarize today's conference call. John Smith mentioned the new schedule. Contact me at 080-1234-5678.”

The terminal detects “John Smith” as confidential data and “080-1234-5678” as personal data, replacing them with “[NAME]” and “[PHONE_NUMBER]” respectively. The anonymized message becomes:

“Please summarize today's conference call. [NAME] mentioned the new schedule. Contact me at [PHONE_NUMBER].”

If the emotional tone is detected as “neutral,”this information is also attached.

The server constructs a prompt for the generative AI model, for example:

Summarize the following conference call notes. Speaker names and phone numbers are anonymized. Emotion: neutral.

Input: Please summarize today's conference call. [NAME] mentioned the new schedule. Contact me at [PHONE_NUMBER].

The generative AI model processes this input and returns a summary, which the server then verifies, adjusts if necessary, and sends back to the terminal.

In this manner, the system enables secure, privacy-preserving, and user-adaptive information processing and communication with external generative AI models using prompt sentences.

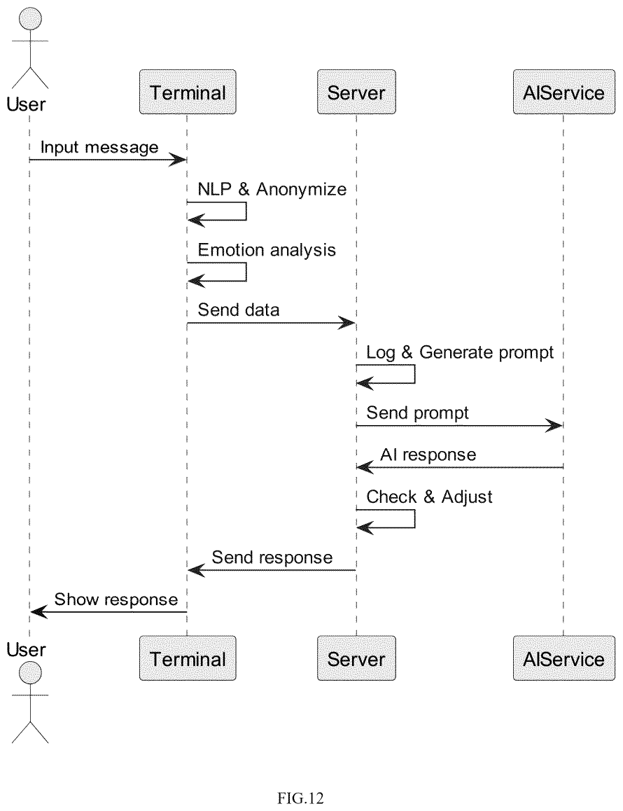

The following describes the processing flow using FIG. 12.

### Step 1:

User enters a message or document on the terminal device by typing or speaking. The input consists of textual or spoken information such as questions, requests, or notes. The output of this step is the raw message in text form, displayed on the terminal and forwarded to the processing module.

### Step 2:

Terminal converts spoken input to text if necessary and stores the raw data in local memory. The input is the raw user message, which may be in voice or text format. The output is a digital text string, ready for further processing, and displayed for user confirmation if needed.

### Step 3:

Terminal applies natural language processing techniques, using libraries such as spaCy or NLTK, to analyze the text and detect confidential data and personal data through tokenization and named entity recognition. The input is the user's text message; the output is a version of the message with tagged sensitive entities (e.g., PERSON, NUMBER, EMAIL), along with metadata indicating their positions in the text.

### Step 4:

Terminal automatically replaces or deletes the detected confidential data and personal data with predefined encoded elements, such as “[NAME]” or “[PHONE_NUMBER]”. The input is the tagged message and entity metadata. The terminal performs replacement or deletion operations on the string and outputs an anonymized message, where all detected sensitive data has been masked with placeholders.

### Step 5:

Terminal analyzes the anonymized message for emotional content using an emotion analysis engine, possibly leveraging sentiment analysis models from Huggingface or similar frameworks. The input is the anonymized text. The output is an emotion label (such as “neutral”, “joy”, or “anger”) attached as metadata to the processed message.

### Step 6:

Terminal transmits the anonymized message and emotion label to the server via a secure (e.g., HTTPS) communication channel. The input is the anonymized and emotion-tagged message. The output is a data packet sent to the server containing the processed information and metadata.

### Step 7:

Server receives the transmitted data and logs the information, including details of anonymization, emotional analysis, and the time of receipt, into a database such as PostgreSQL. The input is the anonymized and emotion-tagged message from the terminal. The output is an updated log entry and a data set ready for further processing.

### Step 8:

Server generates a prompt sentence for the generative AI model, combining the anonymized information, emotion label, and any required input instructions. The input is the log entry and the anonymized message with emotion metadata. The server formats this information as a prompt suitable for the AI API and outputs a composed prompt sentence.

### Step 9:

Server sends the prompt sentence to the generative AI model using an API request protocol, such as REST. The input is the formatted prompt sentence. The output is the response data received from the external generative AI model.

### Step 10:

Server receives the generative AI model's output and performs a secondary check to ensure that confidential or personal data has not been inadvertently included in the response. The input is the AI-generated response. The server applies the same anonymization logic if necessary and outputs a verified, safe response.

### Step 11:

Server analyzes the user's emotion label and adjusts the style or content of the AI output to suit the user's detected emotional state, which may include modifying phrasing or tone for empathy or clarity. The input is the verified response and emotion metadata. The output is a user-ready message tailored to the user's emotional context.

### Step 12:

Server transmits the final, anonymized, and context-appropriate response to the terminal, and updates the log with all corresponding process details. The input is the tailored AI response. The output is the processed message delivered to the terminal and a final log entry.

### Step 13:

Terminal displays the final response to the user via the user interface, such as screen notification, text area, or message popup. The input is the received AI output refined by the server. The output is the response presented directly to the user in an accessible and appropriate manner.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In information processing systems that include communication with generative artificial intelligence models, it is necessary to appropriately recognize and respond to a user's emotional state, secure the safe handling of confidential and personal data, and create emotionally attuned prompt sentences for AI models. Conventional systems suffer from insufficient emotion recognition, lack of dynamic response tone adjustment, and inadequate detection and protection of confidential and personal data, resulting in the risk of information leakage and inappropriate responses that reduce user experience.

The specific processing by the specific processing unit 290 of the data processing device 12 in Example 2 is realized by the following means.

The present invention provides a server comprising a processor configured to receive data, recognize emotion information from the data, dynamically adjust response content according to the recognized emotion, detect confidential and personal data, automatically replace or delete such data with generalized elements, transmit processed data to an external computation service utilizing a generative learning model with created prompt sentences, and record each processing step. This enables both the secure and effective handling of sensitive information and the delivery of emotionally appropriate, high-quality responses in communication systems incorporating generative artificial intelligence models.

The term “processor” refers to a computing element or central unit that executes instructions to perform data processing tasks within a system.

The term “emotion information” refers to data or labels that indicate a user's emotional state, such as happiness, frustration, confusion, or other psychological conditions, as determined by analysis of input data.

The term “response content” refers to the information or message generated to reply to a user or system input, which can be adapted according to context or emotional state.

The term “confidential data” refers to information that should be protected due to its sensitive nature, including but not limited to business secrets, security details, non-public proprietary information, and other restricted data.

The term “personal data” refers to information that identifies or can be used to identify an individual, such as names, contact details, identification numbers, and similar attributes.

The term “generalized elements” refers to abstracted or non-specific symbols, placeholders, or representations used in place of confidential or personal data to prevent identification or disclosure.

The term “external computation service” refers to a computing resource located outside the system, capable of processing, analyzing, or generating data, such as a cloud-based artificial intelligence service.

The term “generative learning model” refers to a machine learning model capable of producing new content, such as text, based on learned patterns or data, including, without limitation, large language models.

The term “prompt sentence” refers to an input statement or query formed to elicit a specific output or response from a generative learning model.

The term “natural language processing” refers to a set of computational techniques and algorithms for analyzing, understanding, and generating human language data.

An embodiment for practicing the invention will now be described in detail.

The system is constructed from a server equipped with a processor, one or more user terminals, and a connection to an external computation service, such as a cloud-based generative AI model. The server and terminals may be implemented on general-purpose computing hardware such as commercial servers, workstations, or mobile devices, operating standard operating systems (for example, Linux, Windows, or Android/iOS). The processor executes program code written in a programming language such as Python, Java, or JavaScript, utilizing software libraries for natural language processing, secure communication, and data handling. Suitable natural language processing software may include open-source libraries such as spaCy, NLTK, or deep learning frameworks including pre-trained models like BERT or those available through cloud-based machine learning platforms.

The terminal receives input data from the user, which may include textual queries, statements, or requests. For example, the user may input the prompt sentence:

“I don't understand what this error code means. Can you help?”

The terminal is equipped with an emotion recognition module, which analyzes the user's input using natural language processing techniques to determine the corresponding emotion information, such as “confusion”, “frustration”, or “curiosity”. The emotion recognition module can be realized with tools such as spaCy or fine-tuned BERT models for sentiment and emotion classification.

Upon determining the user's emotion, the terminal transmits the input data and recognized emotion, via secure channels (such as TLS-protected HTTPS), to the server for further processing. The server receives this transmission, parses the message, and analyzes the textual content for the presence of confidential data or personal data. The server utilizes algorithms such as regular expression matching or integrates with advanced data loss prevention systems, such as those available through widely used cloud security APIs.

If confidential data or personal data is detected, the server automatically replaces such data with generalized elements, such as placeholders like “[USERNAME]” or “[ID_NUMBER]”, or removes the information according to predefined rules. The processed data, now free from sensitive content, is then used to construct a prompt sentence for the external generative AI model. The server composes a message that integrates both the sanitized user query and the identified user emotion and transmits this prompt to the external computation service via the appropriate API. For example, the prompt sent might be:

“User Emotion: Confusion. Prompt: I don't understand what this error code means. Please provide a clear, supportive explanation.”

The external computation service, consisting of a generative AI model, analyzes the prompt and generates a response suitable to the detected emotion and query. This response is returned to the server, which may further review the response for appropriateness and compliance with security or communication policies. The final response is then transmitted back to the user terminal, where it is presented to the user through the application interface.

All data handling steps, including data reception, emotion recognition, masking of confidential and personal information, construction and transmission of the prompt sentence, interaction with the generative AI model, and response delivery, are logged securely on the server for compliance and audit purposes using tools such as Python's logging library or commercial logging platforms.

For example, in the embodiment, if the user initially sends the prompt sentence:

“The system keeps saying ‘access denied’ and I can't do my work.”

The system will determine the user's emotion as “frustration”, sanitize any detected personal or confidential details, and generate and deliver a supportive, informative response tailored to the user's emotional state.

This architecture allows for flexible integration with various terminal devices and generative AI services, supports customizable emotion recognition modules, and ensures a high level of data privacy and response personalization, thus meeting the demands of modern information processing platforms.

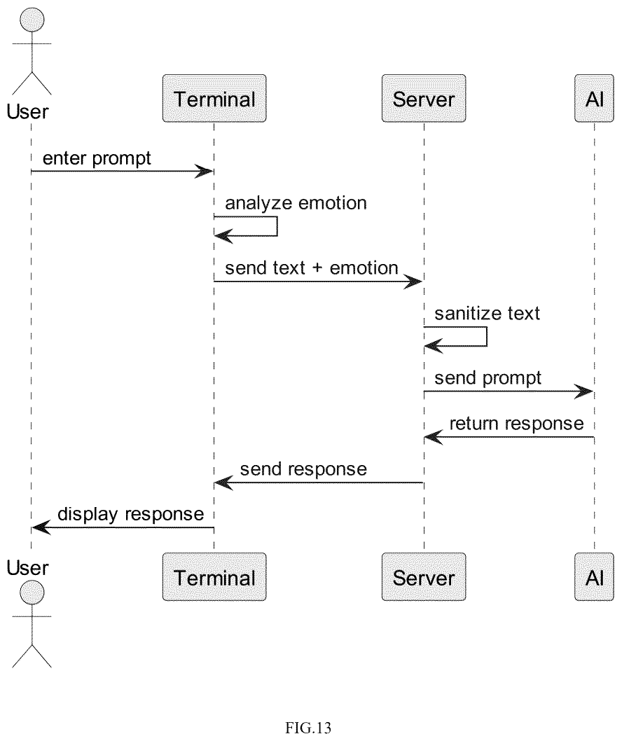

The following describes the processing flow using FIG. 13.

### Step 1:

User enters a prompt sentence, such as “I don't understand what this error code means. Can you help?” using the terminal device. The input is textual data representing the user's query or request.

### Step 2:

Terminal receives the input text and processes it using a natural language processing module, such as spaCy or a BERT-based emotion classification model, to analyze and recognize the user's emotion. The input is raw text, and the output is the detected emotion label (for example, “confusion”or “frustration”) associated with the text.

### Step 3:

Terminal combines the original text and the detected emotion into a data payload.

The input is the user's input text and the extracted emotion label. The output is a structured data packet containing both elements. Terminal transmits this payload to the server over a secure communication channel such as HTTPS.

### Step 4:

Server receives the data payload and parses the content to extract the prompt sentence and the emotion label. Server applies pattern-matching algorithms, such as regular expressions or DLP API calls, to detect confidential data and personal data within the prompt sentence. The input is the data payload; the output is the prompt sentence with any detected sensitive information replaced or removed according to predefined replacement rules, such as substituting names or numbers with generic placeholders like “[USERNAME]”.

### Step 5:

Server constructs a new prompt sentence for the generative AI model, incorporating the sanitized text and the emotion information. The input is the sanitized prompt sentence and the emotion label. The output is a formatted prompt text, such as, “User Emotion: Confusion. Prompt: I don't understand what this error code means. Please provide a clear, supportive explanation.” Server sends this prompt to the external computation service hosting the generative AI model via API.

### Step 6:

External computation service processes the received prompt sentence using a generative AI model and generates a response tailored to both the user's query and recognized emotion. The input is the prompt sentence provided by the server; the output is a response message crafted to address the user's needs and emotional state.

### Step 7:

Server receives the generated response from the external computation service. Server reviews the response, optionally performing additional screening for appropriateness and inadvertent disclosure of any sensitive information. The input is the response message from the external computation service, and the output is the final approved response.

### Step 8:

Server transmits the final response to the terminal over a secure connection. Terminal receives the response message, prepares it for presentation, and displays it to the user in the terminal's user interface, such as a business chat application. The input is the final response, and the output is the rendered feedback visible to the user.

### Step 9:

User reads the response from the terminal and, if necessary, enters a new prompt sentence to continue the interaction. The input is the displayed response; the output is a user's follow-up action, restarting the processing cycle if desired.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems do not consider the user's emotional state when handling information, which can lead to increased user stress during information exchange or response delivery. Moreover, it is difficult to simultaneously achieve both the protection of confidential information and the enhancement of user experience. Systems that process personal or confidential information often face challenges in ensuring data security while providing contextually appropriate and empathetic feedback tailored to a user's emotional state.

The specific processing by the specific processing unit 290 of the data processing device 12 in Application Example 2 is realized by the following means.

The present invention provides a server comprising a processor configured to acquire input information, analyze the input information to identify confidential data, automatically replace or delete the confidential data with predetermined symbols, acquire user state information, generate instruction sentences based on the user state information for a generative information processing device, transmit the instruction sentences and processed data to the generative information processing device, receive user state-adapted output information, notify a terminal with the output information, and record a history of processing steps. This enables secure and context-sensitive communication by protecting confidential information while delivering responses that are optimized for the user's emotional state, thereby reducing user stress and improving the overall user experience.

The term “input information” refers to data received from a user or an external device, including but not limited to text, audio, visual images, and other types of user-provided or sensed content.

The term “attribute information” refers to specific characteristics or features extracted from the input information, such as names, account numbers, identifiers, dates, or other data elements relevant for identification or categorization.

The term “confidential information” refers to any type of data that is subject to privacy protection, including personal information, sensitive business information, or any information that must be handled securely to comply with legal or ethical standards.

The term “predetermined symbol” refers to a placeholder or masking character that is defined in advance and used to replace or obscure confidential information, such as generic tags, asterisks, or other masking formats.

The term “user state information” refers to data representing the emotional or contextual state of a user, which may be derived from sensor input, behavioral analysis, or direct user input, and can include emotional labels, physiological signals, or other contextual data.

The term “instruction sentence” refers to a formatted prompt or directive generated for input to a generative information processing device, designed to guide the response according to the user state or context.

The term “generative information processing device” refers to a computational unit, such as an artificial intelligence model, capable of generating output data or responses based on received prompts and associated data.

The term “output information” refers to the response generated by the generative information processing device, which is adapted to the user state and sanitized for confidential content.

The term “terminal” refers to an electronic device used by the end user to interact with the system, which may include display functions and user input/output features.

The term “history of processing steps” refers to a record of the operations performed on input information, including identification, replacement, generation, transmission, and notification events, for auditing or traceability purposes.

One embodiment of the present invention provides an information processing system that enables secure and context-aware communication between a user and an external service by taking into account confidential information and the user's emotional state. In this embodiment, the system comprises a terminal operated by the user and a server that executes the primary processing.

The terminal may be implemented as a wearable smart device, such as smart glasses. This terminal includes hardware such as a camera and microphone for capturing the user's facial expressions and voice. The software running on the terminal includes image analysis and machine learning frameworks such as OpenCV and TensorFlow, which are used to analyze facial and vocal features of the user. Based on this analysis, the terminal classifies the user's current emotional state, generating a user state information label including, for example, “happy,” “sad,” or “dissatisfied. ” The terminal also acquires user-provided text data, such as dictation or input messages.

The server comprises a processor configured to receive and process data from the terminal. Input information, which includes user messages and the user's emotional state label, is analyzed using natural language processing libraries and frameworks such as NLTK or SpaCy (both implemented in Python or equivalent programming languages). The server identifies attributes corresponding to confidential information, such as personal names, dates, or account numbers, using named entity recognition or similar functions. Identified confidential information is automatically replaced or deleted with a predetermined symbol, such as a placeholder-for example, “[PERSON]” or “[DATE]” to ensure security and privacy.

Subsequently, the server utilizes the user state information to generate an instruction as a prompt sentence that guides a generative AI model in the context of the user's emotional condition. For instance, if the emotion label is “dissatisfied,” the server generates the following prompt sentence:

“When the user expresses dissatisfaction, please provide the message in a gentle and empathetic tone.”

The server combines the processed message data with the prompt sentence and sends these to the generative AI model, which can be implemented on the server itself or accessed via an external API (e.g., a large language model platform).

The generative AI model produces a response adapted both to the sanitized message content and to the user's emotional state. The server then receives and forwards this output information to the terminal. The terminal presents the response to the user, for example, by displaying it on the smart glasses'heads-up display or reading it out loud through a text-to-speech engine such as Google Text-to-Speech.

The server is further configured to record a history of the processing steps, including acquisition, analysis, replacement or deletion of confidential information, prompt generation, response generation, and communication events. This log may be stored, for example, within a log management framework for auditing and traceability.

An example of the prompt sentence generated by the server is as follows:

“When the user expresses dissatisfaction, please provide the message in a gentle and empathetic tone.”

Through this configuration, the system enables delivery of responses that preserve confidential information while optimizing communication for the user's current emotional state, thus reducing user stress and enhancing the overall experience.

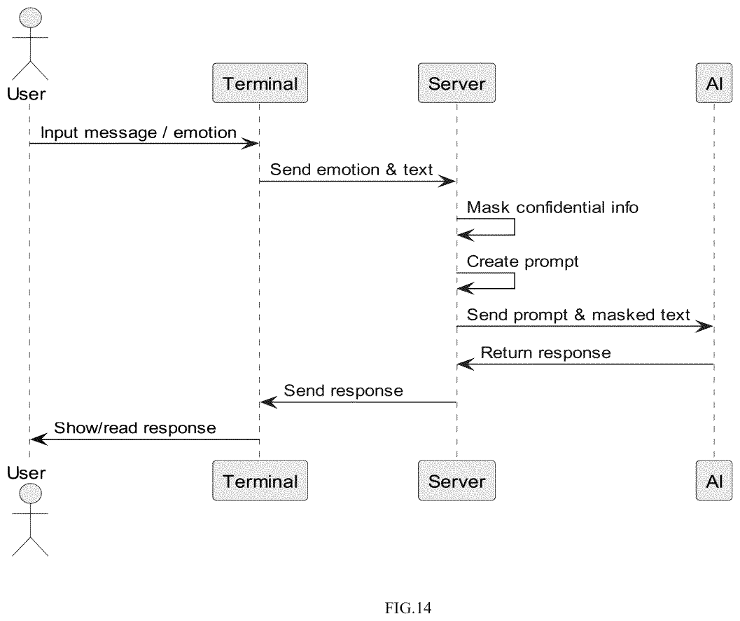

The following describes the processing flow using FIG. 14.

### Step 1:

The terminal captures the user's facial expressions using an integrated camera and records the user's voice via a microphone. As input, the terminal receives real-time video and audio signals from these sensors. The terminal analyzes the video frames using OpenCV to extract facial features such as mouth curvature and eye movement, and uses TensorFlow to process both visual and audio data for emotion classification. The output is a user state information label, for example, “dissatisfied,”along with a timestamp.

### Step 2:

The terminal acquires text input from the user, either by receiving typed or dictated messages. The input is the user's message, captured via keyboard or automatic speech recognition. The terminal sends both the emotion label generated in Step 1 and the message data to the server over a secure network connection. The output is a combined data packet containing the user state information and the user's written or spoken input.

### Step 3:

The server receives the data packet containing the user's text message and emotion label from the terminal. As input, the server obtains this transmitted packet. The server uses natural language processing libraries such as NLTK and SpaCy to analyze the text for confidential information, performing tokenization and named entity recognition to identify personal data. The server replaces recognized confidential data, such as names or dates, with predetermined placeholders (e.g., “[PERSON]” or “[DATE]”). The result is a sanitized or masked version of the user's original message.

### Step 4:

The server generates a prompt sentence specific to the detected user state information. The input to this step is the user's emotion label, for example, “dissatisfied.” Based on this label, the server constructs a tailored prompt sentence, such as:

“When the user expresses dissatisfaction, please provide the message in a gentle and empathetic tone.”

The output is a combined payload containing the sanitized text and the prompt sentence.

### Step 5:

The server sends the payload (the masked message and the prompt sentence) to a generative AI model, either via an internal interface or an external API. The input is the processed payload from Step 4. The generative AI model processes the input and generates an output message adapted to both the sanitized content and the user's emotional state. The output is an empathetic, context-aware response.

### Step 6:

The server receives the response message from the generative AI model. The input is the response generated by the AI. The server logs the entire processing history, including the steps of data reception, confidential information detection and replacement, prompt sentence construction, communication with the AI model, and the final response. The output includes an updated processing log and the AI-generated message.

### Step 7:

The server transmits the AI-generated response message to the terminal along with any relevant status indicators. The input is the confirmed response and processing status from Step 6. The output is the delivery of the response message to the terminal.

### Step 8:

The terminal presents the response message to the user. The input is the empathy-adapted response received from the server. The terminal displays the message through the smart glasses'display and, if enabled, uses a text-to-speech engine to read the message aloud via speakers. The output is the visual and/or auditory feedback experienced by the user.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a na_ïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

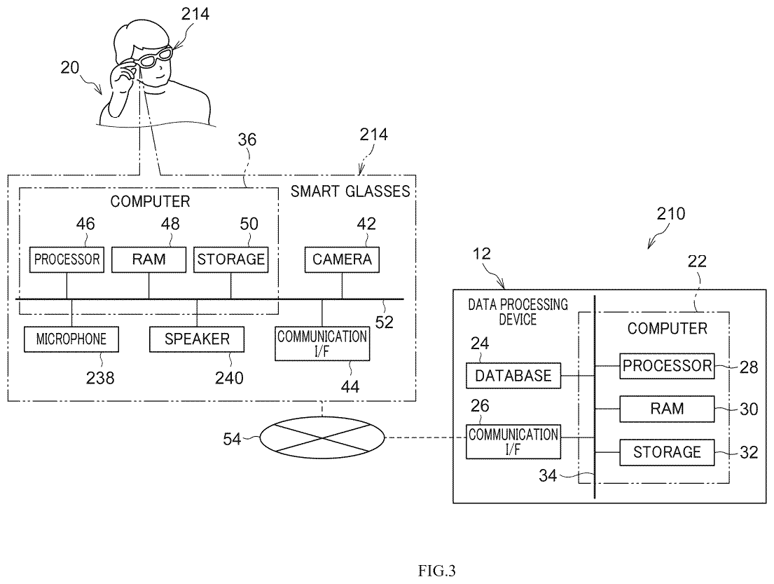

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

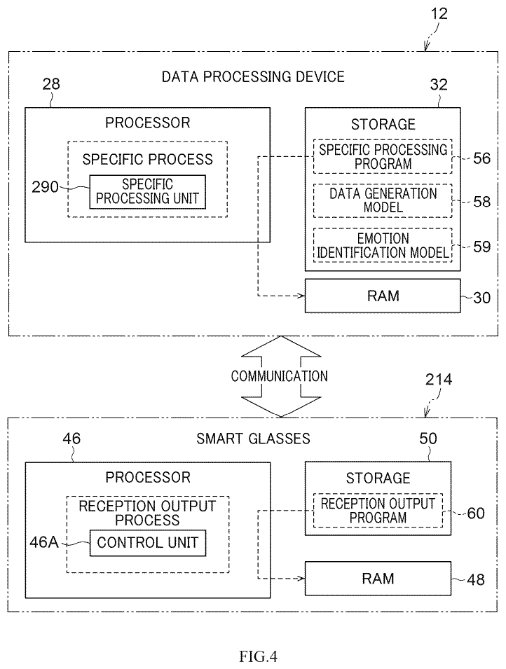

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data. The data generation model 58 is a so-called generative artificial intelligence (AI). Examples of the data generation model 58 include generative AIs such as ChatGPT (registered trademark) (Internet search <URL: https: //openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

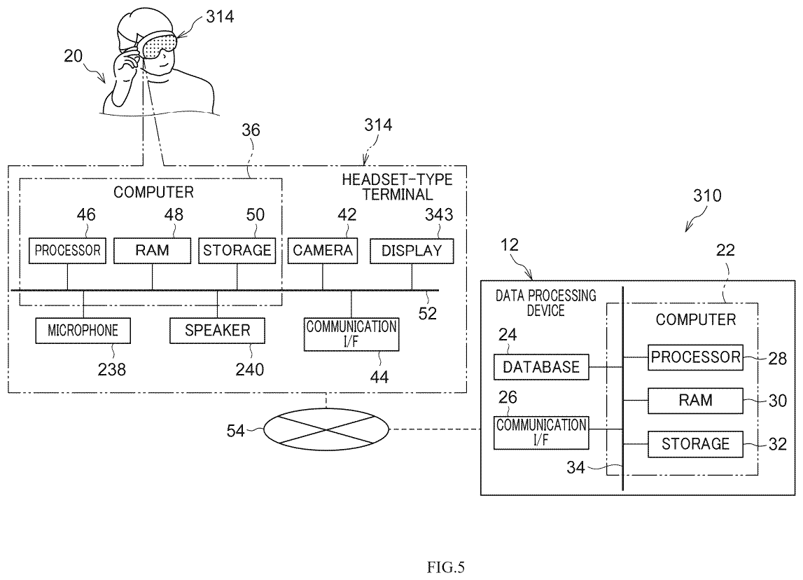

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

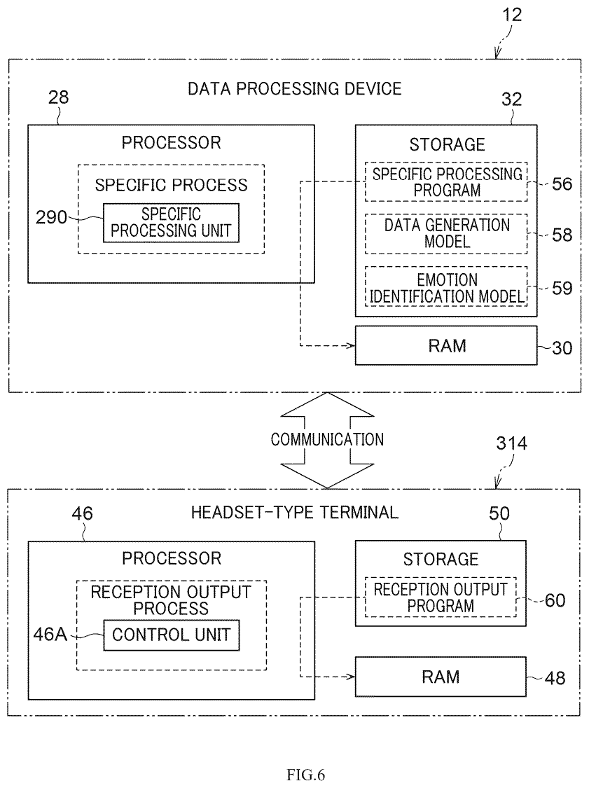

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a nana_ïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

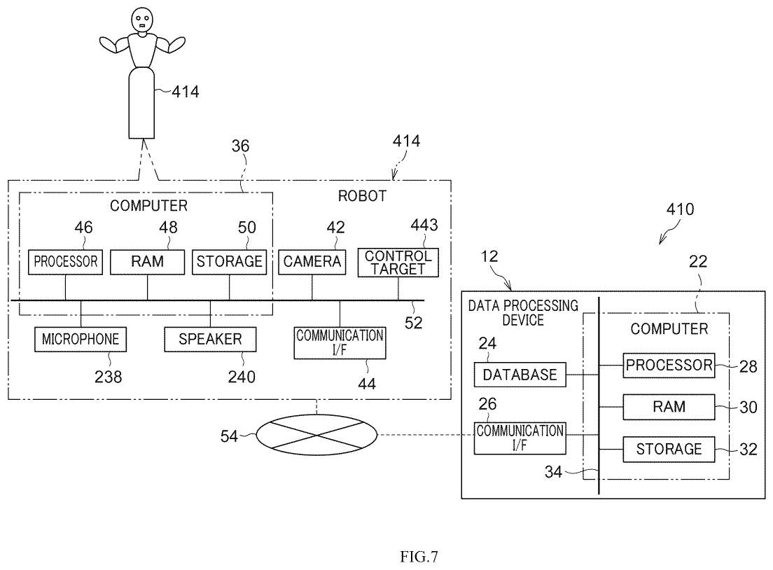

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

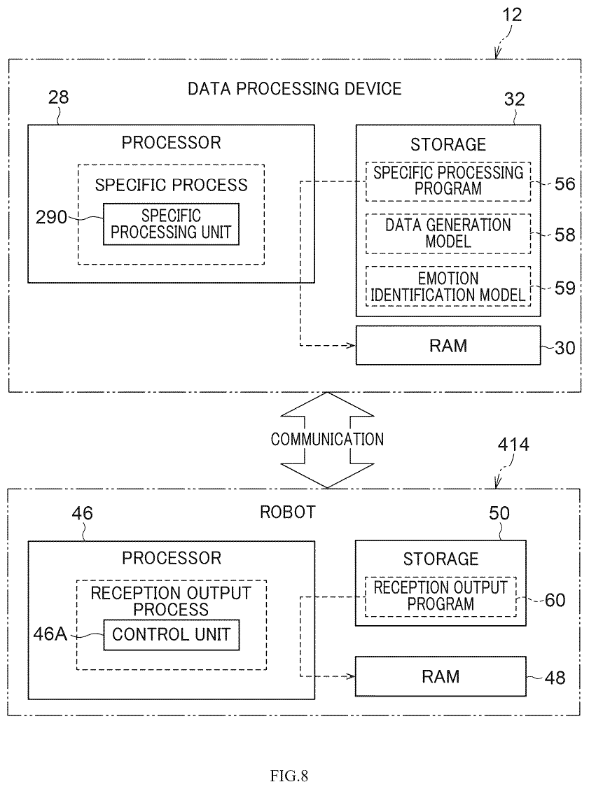

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

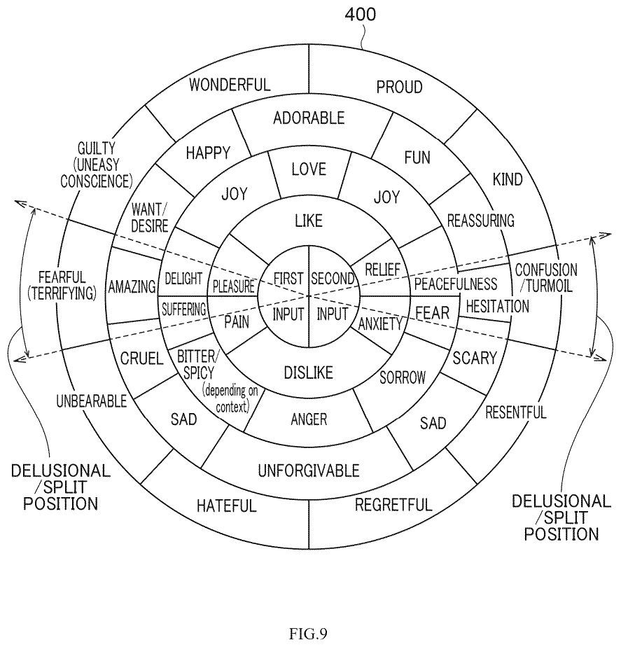

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o′ clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

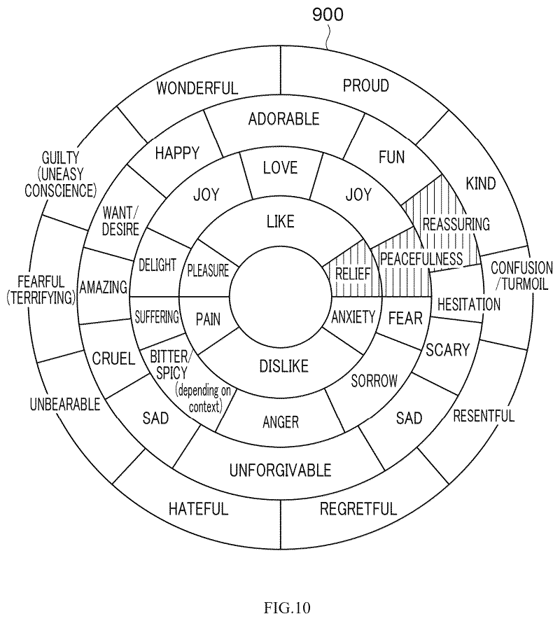

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured”are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive input data;
verify information of the received input data and confirm integrity of the data;
transfer the input data, upon verification, to an electronic device suitable for natural language analysis processing;
extract and identify, using natural language processing technology, high-confidentiality attribute information and highly-identifiable attribute information from the received input data automatically;
automatically replace or remove the extracted and identified attribute information with higher-level concept identifiers or symbols;
transmit the anonymized input data to an external generative information processing apparatus;
generate a prompt sentence to be attached for communication with the external generative information processing apparatus; and
record processing details including data modification steps and transmission steps with associated time information.

### (Supplementary 2)

The system according to supplementary 1,
wherein the processor is configured to extract attribute information by utilizing multiple types of language analysis program resources and extracting attribute information based on pattern matching or dictionary reference during the natural language analysis processing.

### (Supplementary 3)

The system according to supplementary 1,
wherein the processor is configured to embed higher-level concept identifiers in the data when replacing the attribute information.

### Application Example 1

### (Supplementary 1)

A system comprising a processor,
wherein the processor is configured to
receive information;
analyze the received information to detect confidential data and personal data; automatically replace or delete the detected confidential data and personal data; transmit the information including replaced or deleted data to an external information processing service;
generate an input instruction sentence to be attached to the transmitted information; analyze response data received from the external information processing service to detect and replace or remove confidential data and personal data contained therein;
record the processing history;
analyze user emotion; and
adjust the content or manner of output information based on the result of the emotion analysis.

### (Supplementary 2)

The system according to supplementary 1,
wherein the processor is configured to detect confidential data and personal data by using natural language processing techniques during the analysis of the received information.

### (Supplementary 3)

The system according to supplementary 1,
wherein the processor is configured to use predefined encoded elements in replacing the detected confidential data and personal data.

### Example 2

### (Supplementary 1)

A system comprising a processor,
wherein the processor is configured to receive data,
analyze the received data to recognize emotion information,
dynamically adjust response content based on the recognized emotion information,
analyze the received data to detect confidential data and personal data,
automatically replace or delete the detected confidential data and personal data with generalized elements,
transmit the processed data to an external computation service,
utilize a generative learning model in response processing and create an input sentence as a prompt,
and record each processing step.

### (Supplementary 2)

The system according to supplementary 1,
wherein the processor is configured to
employ natural language processing for recognizing emotion information and for detecting confidential data and personal data during data analysis.

### (Supplementary 3)

The system according to supplementary 1,
wherein the processor is configured to
use predefined abstract elements or placeholders consisting of symbols to replace the confidential data and personal data.

### Application Example 2

### (Supplementary 1)

A system comprising a processor,
wherein the processor is configured to
acquire input information,
analyze attribute information contained in the acquired input information to identify confidential information,
automatically replace or delete the identified confidential information with a predetermined symbol,
acquire user state information relating to the input information,
generate an instruction sentence for a generative information processing device based on the user state information,
transmit the instruction sentence and the replaced or deleted information to the generative information processing device, and receive output information adapted to the user state information,
notify a terminal with the output information,
and record a history of processing steps.

### (Supplementary 2)

The system according to supplementary 1,
wherein the processor is configured to use language processing technology to identify confidential information during analysis of the input information or attribute information.

### (Supplementary 3)

The system according to supplementary 1,
wherein the processor is configured to use a predefined symbol for the automatic replacement process.

What is claimed is:

1. A system comprising a processor,
wherein the processor receives information,
analyzes the received information to detect confidential information and personal information,
automatically replaces or deletes detected confidential information and personal information,
transmits the processed information to an external service,
and records the processing steps.

2. The system of claim 1, wherein the processor detects confidential information and personal information in the course of information analysis by using natural language processing techniques.

3. The system of claim 1, wherein the processor, in replacing confidential information and personal information, uses pre-defined placeholders.
